(19) United States
(12) Patent Application Publication
(10) Pub. No.: US 2023/0365137 A1
(43) Pub. Date: Nov. 16, 2023

(54) METHOD FOR OPERATING A MOTOR VEHICLE, AND MOTOR VEHICLE

(71) Applicant: Volkswagen Aktiengesellschaft, Wolfsburg (DE)

(72) Inventor: Octavian Tirla, Berlin (DE)

(21) Appl. No.: 18/027,884

(22) PCT Filed: Aug. 31, 2021
(86) PCT No.: PCT/EP2021/073938

§ 371 Date: Mar. 31, 2023

(30) Foreign Application Priority Data
Sep. 28, 2020 (DE) 102020212165.6

(51) Int. Cl. B60W 40/08; B60W 60/00; B60W 40/04

(52) U.S. Cl. CPC B60W 40/08; B60W 60/0051; B60W 40/04; B60W 2540/21; B60W 2540/229; B60W 2540/225; B60W 2540/223

(57) ABSTRACT

Technologies and techniques for operating a motor vehicle, in which the vehicle driver is monitored by at least one monitoring device of the motor vehicle, and a check is carried out as to whether, according to a predefined criterion, the vehicle driver is distracted by an operator control intention or an operator control action which has already taken place. The at least one monitoring device monitors manual operation of at least one operator control unit and, if the vehicle driver is distracted according to the predefined criterion, the vehicle driver or another occupant is offered or forced to use an alternative operator control type by the motor vehicle.

### RELATED APPLICATIONS

The present application claims priority to international Patent Application No. PCT/EP2021/073938 to Octavian Tirla, titled “Method For Operating A Motor Vehicle And Motor Vehicle”, filed Aug. 31, 2021, which claims priority to German Patent App. No. DE 10 2020 212 165.6, filed Sep. 28, 2020, the contents of each being incorporated by reference in their entirety herein.

### BACKGROUND

The present disclosure relates to a method for operating a motor vehicle, in which the vehicle driver is monitored by at least one monitoring device of the motor vehicle, and the result of this monitoring process is evaluated to be able to avoid that a distracted vehicle driver causes a hazardous situation.

As way of background, US 2018/0 319 407 A1 describes a method in which the monitoring device is designed as a camera system, by means of which the vehicle driver is observed. The camera images are evaluated as to whether the driver is looking at the road or is distracted by averting his or her gaze from the road. It is furthermore possible to recognize whether the driver would like to switch from an autonomous driving mode into a manual driving mode. If this is the case, a driver's seat is automatically displaced into a suitable position in which the driver is able to take over the driving task.

It is also known from U.S. Pat. No. 10,336,323 B2 to detect the viewing direction of a vehicle driver of a motor vehicle. A decision is made, as a function of a recognized viewing direction, as to whether signals are transmitted to an accident prevention system of the motor vehicle. Different degrees of distraction can be provided for different vehicle drivers, wherein the number of warnings output by means of the accident prevent system is established as a function of the degree of distraction, and the extent to which less relevant information is shown on a display of the vehicle is established.

DE 10 2017 204 424 A1 describes a method for providing a usage profile of a user of a motor vehicle. The usage profile describes the usage behavior of a driver with respect to a comfort technology function. If the same user later uses a different motor vehicle, it is checked whether the comfort technology function is presently being provided in an activated state. Furthermore, it is checked whether a hazardous situation is present. If the comfort technology function is deactivated while a hazardous situation is present, a warning signal is generated, which alerts the relevant user to the hazardous situation.

In general, it is known that infotainment systems in the car not only ensure greater comfort, but also increase the risk of accidents because these systems can distract the vehicle driver. Vehicle drivers who allow themselves to become distracted through the use of the navigation system or through the use of the on-board computer have higher accident rates than those that occur with vehicle drivers who do not have such sources of distraction available to them. Special comfort functions, in particular during use, such as scrolling though the navigation system, operating the air conditioning system in the vehicle, or reading speed limits that presently apply while driving from the head-up display, distract the driver from driving the motor vehicle safely. Simply shutting off or prohibiting vehicle functions or their operation while driving decreases the very comfort that is intended to be provided by the operating functions. Some vehicle drivers resort to smart phones while driving, for example to utilize functions such as navigation, communication or entertainment when the use of such functions is suppressed by vehicle systems. A pure warning is also not always helpful.

### SUMMARY

Aspects of the present disclosure are directed to modifying how the motor vehicle guides the vehicle driver in such a way that he or she feels less patronized, without safety aspects being neglected.

In some examples, a method is disclosed for operating a motor vehicle in which the vehicle driver is monitored by at least one monitoring device of the motor vehicle, and in which it is checked whether the vehicle driver is distracted by an operating intention or an operating action that is already in progress. Manual actuation of operating units may be monitored by at least one monitoring device, and an alternative operating type is offered to or imposed on the vehicle driver by the vehicle if he or she is distracted according to the predetermined criterion.

The alternative operating type may be that the manual operation is simplified by the operating unit, that is, functions are less complex than otherwise offered to the vehicle driver by the motor vehicle.

In one exemplary embodiment, the alternative operation includes that the operating unit switches, or operating units switch, to an operation by means of voice control, in place of the manual actuation.

In some examples, the operation may be carried out by the front-seat passenger, wherein, for this purpose, arrows and/or a flashing light on the side of the front-seat passenger are shown to the vehicle driver and the front-seat passenger and/or commands are output on the display or voice commands are output.

In one exemplary embodiment, the predetermined criterion includes that all activities from a predetermined group of activities of the vehicle driver which are not directly related to control of the motor vehicle are taken into consideration. Such activities can include that the vehicle driver is operating an infotainment system, wherein this aspect may also cover the operation of a navigation device, that the on-board computer is being operated and/or that the vehicle driver is carrying out switching processes and similar operating actions (“scrolling through the menu”) at the dashboard of the motor vehicle.

In some examples, each of the activities from the predetermined group may contribute to the establishment of a numerical value. The predetermined criterion then includes that a value beyond a threshold value is reached for the numerical value (for example, it can be detected, when adding up numerical values, that a threshold value was exceeded). It is also possible for such numerical values or other pieces of binary information, and the like, which are processed with one another other than by pure addition, to be assigned to the activities. For example, multiple numerical values may be multiplied, for example in sub-groups. The numerical value can also be subtracted in the case of certain activities or serve as the quotient in the case of a division.

In one exemplary embodiment, it is provided that the threshold value is defined at least as a function of a degree of a semi-autonomous driving operation of the motor vehicle. In this way, the more semi-autonomously the motor vehicle is driving, the more operating actions could be enabled for the vehicle driver. As a result, the vehicle driver feels less patronized.

In one exemplary embodiment, the traffic situation is observed by at least one observation device of the motor vehicle, and the threshold value is defined as a function of at least a degree of necessary attention of the vehicle driver. The goal here is again to enable as many operating actions for the vehicle driver as the traffic situation allows.

The activities from the predetermined group can contribute to the numerical value in a variety of ways. For example, a higher number of points can contribute to a numerical value when the navigation system is being operated than when an operating action is being carried out at a dashboard, where the driver simply scrolls to change the display.

In one exemplary embodiment, the at least one monitoring device detects a) the gaze of the vehicle driver, and/or b) a seat occupancy on the front passenger seat and c) a hand or a finger at an operating unit, wherein in the case of c) this is either assigned to the vehicle driver or to another occupant, typically the front-seat passenger. In this way, it is possible to derive, from the information thus detected, whether the operating intention or the operating action that is already in progress is in fact that of the vehicle driver, and not that of the front-seat passenger. If it is detected that the front-seat passenger would like to carry out or is carrying out the operation, no alternative operating type has to be offered or imposed.

The monitoring device may include at least one camera, or multiple cameras, for the aforementioned purposes so that the detection of the gaze, of the seat occupancy or also of the hand and the corresponding operating person takes place based on camera images.

In some examples, a motor vehicle is disclosed, comprising an operating unit, and at least one device for detecting at least one of:
the occupancy of the driver's seat and/or front passenger seat;
the gaze of the vehicle driver and/or of the front-seat passenger;
the movement of at least one hand of the vehicle driver and/or of the front-seat passenger; and
the movement of a finger of the vehicle driver and/or of the front-seat passenger.

In some examples, the motor vehicle may be configured to derive a degree of a distraction of the vehicle driver based on the information acquired by the device for detecting, as well as changing the operating type if it is recognized in this way that the vehicle driver is distracted.

The advantages of the method according to the present disclosure are likewise also advantages of the motor vehicle according to the present disclosure since expanded options exist for carrying out operating actions while driving.

In one exemplary embodiment, the device for detecting comprises at least one camera, wherein typically a multitude of cameras may be provided.

An observation device for detecting the traffic situation forms part of a motor vehicle according to another exemplary embodiment, wherein the changing of the operating type also takes the traffic situation into consideration.

In one exemplary embodiment, the motor vehicle is furthermore also designed to enable all further above-described embodiments of the method.

Further features of the present disclosure can be derived from the following description of the figure and based on drawing. The features and feature combinations mentioned herein can be used not only in the respectively indicated combination, but also in other combinations, or alone, without departing from the scope of the disclosure.

### BRIEF DESCRIPTION OF THE DRAWINGS

Aspects of the present disclosure will be described in more detail hereafter based on preferred exemplary embodiments with reference to the figures. In the drawings:

FIG. 1 shows a schematic diagram of the units of a motor vehicle according to one embodiment of the disclosure, which is able to carry out the method according to the disclosure; and

FIG. 2 shows a flow chart to illustrate one embodiment of the method according to the disclosure.

### DETAILED DESCRIPTION

Like or functionally equivalent elements are denoted by like reference numerals in the figures.

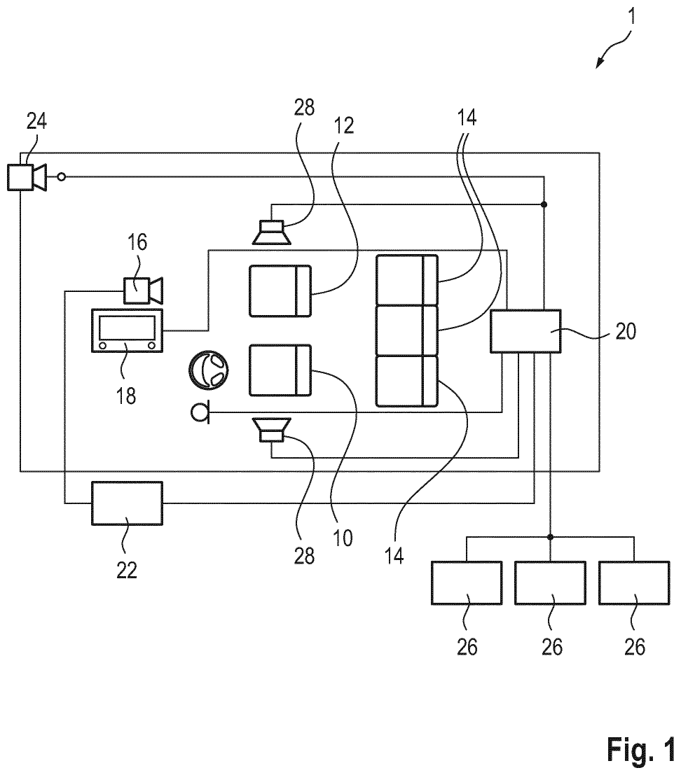

A motor vehicle shown schematically in FIG. 1 and denoted overall by reference numeral 1 comprises the driver's seat 10 and the front passenger seat 12 as well as further seats 14. A camera system, illustrated symbolically here by a single camera 16, includes one or more cameras for observing the vehicle cockpit. Based on the camera images, it is derived which of the seats 10, 12 and 14 in the motor vehicle are occupied. An operating unit 18 can be manually operated by the vehicle driver on the driver's seat 10. In addition to the seat occupancy, it is now detected, by means of the images acquired by the camera system 16, where the driver on the driver's seat 10 is looking, that is, at the road or at the operating device 18, and in which direction his or her hand is moving or his or her individual fingers are moving. It is also possible to derive from the camera images acquired by means of the camera system 16 when a front-seat passenger sitting on the front passenger seat 12 is present and plans or carries out operating actions.

In a control device 20, software is stored in the form of suitable algorithms, which accordingly evaluates the camera images. The aforementioned information is represented as numerical values, which are utilized together by means of the software 22 for deriving a numerical value. For example, the numerical value can be defined in such a way that the numerical value increases as the vehicle driver on the driver's seat 10 becomes increasingly distracted. In this case, a threshold value would then have to be defined, which, when reached or exceeded, means that the vehicle driver is regarded as being distracted.

The threshold value can be variable and, for example, be dependent on the information acquired by means of an observation device 24 for detecting the traffic situation, or on a function 26 that is implemented by the control device 20 and relates to the degree of autonomy with which the motor vehicle is being driven. It is possible in this regard that a gradation from purely autonomous driving, use of a so-called traffic jam pilot, highway pilot and the like is carried out.

In the event that it is established, by means of the threshold value criterion, that the vehicle driver is too distracted to safely drive the vehicle, a warning or a suggestion is optically output on the manually actuatable operating unit. This can be configured in such a way that the vehicle driver can follow or must follow the warning and suggestion. The driver can utilize microphones 28 as an alternative operating type, which are installed in the motor vehicle 1 in order to carry out the operating actions by way of speech, that is, to issue voice commands. In general, any kind of “digital assistance” may be activated here.

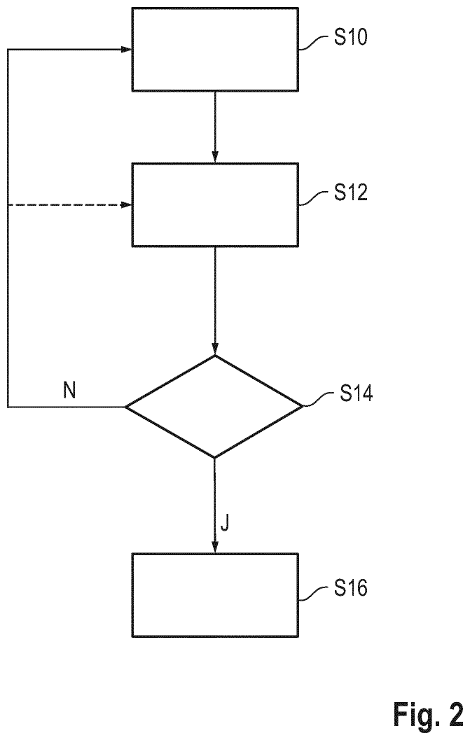

An exemplary method is disclosed in FIG. 2, where, in step S10, the situation in the cockpit is detected, as described above, and, in step S12, the traffic situation is observed, and that, in step S14, it is checked by means of the algorithm 22 in the control device 20 whether the driver, in light of the traffic situation, is too distracted according to a predetermined threshold value criterion. If this is not the case, the method returns to step S10, or alternatively to step S12. If this is the case, in contrast, the method transitions to step S16, in which an operating action, such as is in the process of being carried out or is to be carried out, is suppressed or at least advised against, and an alternative operating type is shown (recommended), and in particular made possible, if this did not previously exist.

### LIST OF REFERENCE SIGNS

1 motor vehicle
10 driver's seat
12 front passenger seat
14 further seats
16 monitoring device
18 operating unit
20 control device
22 software
24 observation device
26 function of the control device 20
28 microphone
S10-S16 method steps

1-10. (canceled)

11. A method for operating a motor vehicle, comprising:
monitoring a vehicle driver by at least one monitoring device of the motor vehicle;
determining whether the monitored vehicle driver is distracted by an operating intention or operating action that is already in progress according to a predetermined criterion;
monitoring, via the at least one monitoring device, a manual actuation of at least one operating unit;
presenting an alternative operating type selection for the motor vehicle to the vehicle driver or occupant if the vehicle driver is distracted according to the predetermined criterion; and
implementing the alternative operating type selection for the motor vehicle.

12. The method according to claim 11, wherein the presenting of the alternative operating type selection comprises presenting a voice control instead of the manual actuation.

13. The method according to claim 11, wherein the predetermined criterion comprises activities from a predetermined group of activities of the vehicle driver that are not directly related to movement and/or directional control of the motor vehicle.

14. The method according to claim 13, wherein the predetermined group of activities comprise one or more of (i) operating an infotainment system, (ii) operating a navigation device, (iii) operating an on-board computer and/or (iv) carrying out switching processes on a dashboard of the motor vehicle.

15. The method according to claim 13, further comprising determining a numerical value based on each of the activities from the predetermined group, wherein the predetermined criterion includes that a numerical value beyond a threshold value of the determined numerical value.

16. The method according to claim 15, wherein the threshold value comprises a function of a degree of semi-autonomous driving of the motor vehicle.

17. The method according to claim 15, further comprising monitoring a traffic situation by at least one observation device of the motor vehicle, and wherein the threshold value comprises a function of at least a degree of attention of the vehicle driver and the monitored traffic situation.

18. The method according to claim 15, further comprising applying different weightings to the different activities to determine the numerical value.

19. An apparatus for operating a motor vehicle, comprising:
an operating unit;
at least one monitoring device, configured to monitor a vehicle driver utilizing one or more of
a gaze of the vehicle driver and/or of a front-seat passenger,
a movement of at least one hand of the vehicle driver and/or of the front-seat passenger, and
a movement of at least one finger of the vehicle driver and/or of the front-seat passenger; and
a processing apparatus configured to
determine whether the monitored vehicle driver is distracted by an operating intention or operating action that is already in progress according to a predetermined criterion;
present an alternative operating type selection for the motor vehicle to the vehicle driver or occupant if the vehicle driver is distracted according to the predetermined criterion; and
implement the alternative operating type selection for the motor vehicle.

20. The apparatus according to claim 19, wherein the processing apparatus is configured to present the alternative operating type selection by presenting a voice control or a manual actuation.

21. The apparatus according to claim 19, wherein the predetermined criterion comprises activities from a predetermined group of activities of the vehicle driver that are not directly related to movement and/or directional control of the motor vehicle.

22. The apparatus according to claim 21, wherein the predetermined group of activities comprise one or more of (i) operating an infotainment system, (ii) operating a navigation device, (iii) operating an on-board computer and/or (iv) carrying out switching processes on a dashboard of the motor vehicle.

23. The apparatus according to claim 21, wherein the processing apparatus is configured to determine a numerical value based on each of the activities from the predetermined group, wherein the predetermined criterion includes that a numerical value beyond a threshold value of the determined numerical value.

24. The apparatus according to claim 23, wherein the threshold value comprises a function of a degree of semi-autonomous driving of the motor vehicle.

25. The apparatus according to claim 23, further comprising a monitoring device for monitoring a traffic situation, and wherein the threshold value comprises a function of at least a degree of attention of the vehicle driver and the monitored traffic situation.

26. The apparatus according to claim 23, wherein the processing apparatus is configured to apply different weightings to the different activities to determine the numerical value.

27. An apparatus for operating a motor vehicle, comprising:
an operating unit;
at least one monitoring device, configured to monitor a vehicle driver utilizing one or more of
a gaze of the vehicle driver and/or of a front-seat passenger,
a movement of at least one hand of the vehicle driver and/or of the front-seat passenger, and
a movement of at least one finger of the vehicle driver and/or of the front-seat passenger; and
a processing apparatus configured to
determine whether the monitored vehicle driver is distracted by an operating intention or operating action that is already in progress according to a predetermined criterion, the operating intention or operating action comprising activities from a predetermined group of activities of the vehicle driver that are not directly related to movement and/or directional control of the motor vehicle;
present an alternative operating type selection for the motor vehicle to the vehicle driver or occupant if the vehicle driver is distracted according to the predetermined criterion; and
implement the alternative operating type selection for the motor vehicle.

28. The apparatus according to claim 27, wherein the processing apparatus is configured to determine a numerical value based on each of the activities from the predetermined group, wherein the predetermined criterion includes that a numerical value beyond a threshold value of the determined numerical value.

29. The apparatus according to claim 28, wherein the threshold value comprises a function of a degree of semi-autonomous driving of the motor vehicle.

30. The apparatus according to claim 27, further comprising a monitoring device for monitoring a traffic situation, and wherein the threshold value comprises a function of at least a degree of attention of the vehicle driver and the monitored traffic situation.
